(19) United States
(12) Patent Application Publication
(10) Pub. No.: US 2025/0021766 A1
(43) Pub. Date: Jan. 16, 2025

(54) TEXTUAL DATASET AUGMENTATION USING LARGE LANGUAGE MODELS

(71) Applicant: NEC Corporation Of America, Herzlia (IL)

(72) Inventor: Tsvi LEV, Tel-Aviv (IL)

(73) Assignee: NEC Corporation Of America, Herzlia (IL)

(21) Appl. No.: 18/219,805

(22) Filed: Jul. 10, 2023

(51) Int. Cl. G06F 40/40; G06F 40/279; G06F 40/30

(52) U.S. Cl. CPC G06F 40/40; G06F 40/279; G06F 40/30

(57) ABSTRACT

A system and a method for augmenting a dataset comprising a textual content using instruction to cause a conversational language model to create variations of text items by changing text properties such as length, style, terminology, dialect, rhyming and the like. The method may also be used with combined prompts and iteratively.

### FIELD AND BACKGROUND OF THE INVENTION

The present invention, in some embodiments thereof, relates to text classification, and, more particularly, but not exclusively, augmenting text in datasets used for machine learning model training.

A lot of text, particularly labelled text, may be needed for training machine learning based natural language processing models. Computer vision model training often comprises applying methods like geometric transformations, brightness and color variations, cropping, and the likes to enrich the dataset.

Preparing a labelled text dataset for training machine learning models may require data collection, cleaning, standardization and annotation. These tasks may require much manual work from domain experts.

Creating large datasets comprising text for machine learning models may be expensive and challenges. Firstly, obtaining a substantial amount of text data can be time-consuming and costly. Additionally, cleaning datasets from information which is sensitive, private, misleading and/or the like may require massive repetitive and careful work of qualified personnel. Annotating large datasets with appropriate labels or categories also requires domain expertise, which may be limited or expensive to obtain. Furthermore, ensuring the quality and consistency of the labelled data can be challenging, as different annotators may have varying interpretations or biases.

### SUMMARY OF THE INVENTION

It is an object of the present invention to provide a system and a method for augmenting a dataset comprising textual content by applying a conversational language model on the textual content using prompts instructing the language model to rephrase text items.

According to an aspect of some embodiments of the present invention there is provided a method for augmenting a dataset comprising textual content, comprising:
receiving a dataset having a plurality of original text items;
receiving a plurality of prompts, each prompt comprising instructions for a language model to rephrase a text item;
processing plurality of original text item and the plurality of prompts to generate a plurality of queries; and
generating a plurality of synthetic text items, each by feeding one of the plurality of queries to at least one conversational language model.

According to an aspect of some embodiments of the present invention there is provided a system comprising a storage and at least one processing circuitry configured to:
receive a dataset having a plurality of original text items;
receive a plurality of prompts, each prompt comprising instructions for a language model to rephrase a text item;
process plurality of original text item and the plurality of prompts to generate a plurality of queries; and
generate a plurality of synthetic text items, each by feeding one of the plurality of queries to at least one conversational language model.

According to an aspect of some embodiments of the present invention there is provided one or more computer program products comprising instructions for augmenting a dataset comprising a textual content, wherein execution of the instructions by one or more processors of a computing system is to cause a computing system to:
receive a dataset having a plurality of original text items;
receive a plurality of prompts, each prompt comprising instructions for a language model to rephrase a text item;
process plurality of original text item and the plurality of prompts to generate a plurality of queries; and
generate a plurality of synthetic text items, each by feeding one of the plurality of queries to at least one conversational language model.

Optionally, further comprising modifying at least one parameter pertaining to the at least one conversational language model.

Optionally, at least one instruction from the instructions for a language model to rephrase a text item refers to detail level of the text item.

Optionally, at least one instruction from the instructions for a language model to rephrase a text item refers to emotional tone of the text item.

Optionally, at least one instruction from the instructions for a language model to rephrase a text item refers to dialect of the text item.

Optionally, at least one instruction from the instructions for a language model to rephrase a text item refers to personal writer style of the text item.

Optionally, at least one instruction from the instructions for a language model to rephrase a text item refers to presence of at least one word in the text item. Optionally, the at least one word is a word associated with a label assigned to the text item.

Optionally, further comprising at least one iteration comprising:
searching for at least one keyword in the text item from the plurality of synthetic text items;
generating at least one prompt comprising instructions for a language model to rephrase a text item by limiting presence of the at least one keyword;
processing plurality of text items from the plurality of synthetic text items and the plurality of original text item and the at least one prompt to generate an additional plurality of queries; and
generating at least one additional synthetic text item, by feeding at least one of the additional plurality of queries to at least one conversational language model.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings and formulae. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary system for text dataset augmentation according to some embodiments of the present disclosure;

FIG. 2 is a schematic diagram of a simplified exemplary text dataset augmentation module, according to some embodiments of the present disclosure;

FIG. 3 is a flowchart of an exemplary process for text dataset augmentation, according to some embodiments of the present disclosure; and

FIG. 4 is a usage of a prompt on a conversational language module for text dataset item augmentation, according to some embodiments of the present disclosure.

### DESCRIPTION OF SPECIFIC EMBODIMENTS OF THE INVENTION

The present invention, in some embodiments thereof, relates to text classification, and, more particularly, but not exclusively, augmenting text in datasets used for machine learning model training.

Dataset augmentation is a technique used to increase the size and diversity of a labelled text dataset for machine learning models, by applying various transformations to the existing dataset, for example randomization, perturbation, or synthesis, to generate additional samples. Augmenting images for computer vision model training is a known practice, and some methods such as knowledge representation rule based rephrasing, automatic translation, optionally including back translation, or synonymous words replacement may be used, however they are limited and may create incoherent text.

Some embodiments of the present invention process some samples, using a generative conversational text model and a bank of prompts comprising instructions to rephrase a text. In this context, rephrase refers to generating a different text having similar meaning, which is expected to be classified by a machine learning model similarly to the original text, however using different vocabularies and styles.

Some embodiments of the present invention apply iterations on model parameters such as temperature to obtain a balance between robustness and coherence of the dataset examples.

Some embodiments of the present invention apply iterative process, comprising generating new prompts to avoid words, phrases, patterns, and/or the like which are common in the dataset in general, or textual contents associated with one or more labels.

Some embodiments of the present invention receive text items directly or apply extraction thereof form a video, a vocal recording, multimodal data, tabular data and/or the like.

Some embodiments of the present invention may apply pre-processing such as translation and filter text for known weaknesses of the translation and/or the conversational language model. The conversational language model may be a large language model trained for various purposes which may not necessarily comprise text classification.

Some embodiments of the present invention may apply comprise statistical analysis on the augmented dataset to compare distributions, features, or other relevant metrics between the original and augmented samples. This may be obtained by a classifier, for example a neural network, where the network comprising an output neuron corresponding to the confidence level the input represents a class.

The layer preceding the output neuron may be represented as a vector of neurons, assigned with values generated for each labeled, original text item.

The classifier may be used for verifying one or more synthetic, augmented text item which was generated using a labeled, original text item, by measuring a distance, for example dot product or Euclidean distance, between the vectors of the layer generated thereby and by the original text. A distance exceeding a certain value may indicate where augmentation altered the text item to a lesser representation of the associated label.

Some embodiment of the present invention, similarly to augmentation for computer vision, sound, and the like, the disclosure provides a method of enriching a dataset for training natural language processing models without further manual labeling, and help increase the accuracy and robustness of models trained by the augmented dataset.

Before explaining at least one embodiment of the invention in detail, it is to be understood that the invention is not necessarily limited in its application to the details of instructions and the arrangement of the components and/or methods set forth in the following description and/or illustrated in the drawings and/or the Examples. The invention is capable of other embodiments or of being practiced or carried out in various ways.

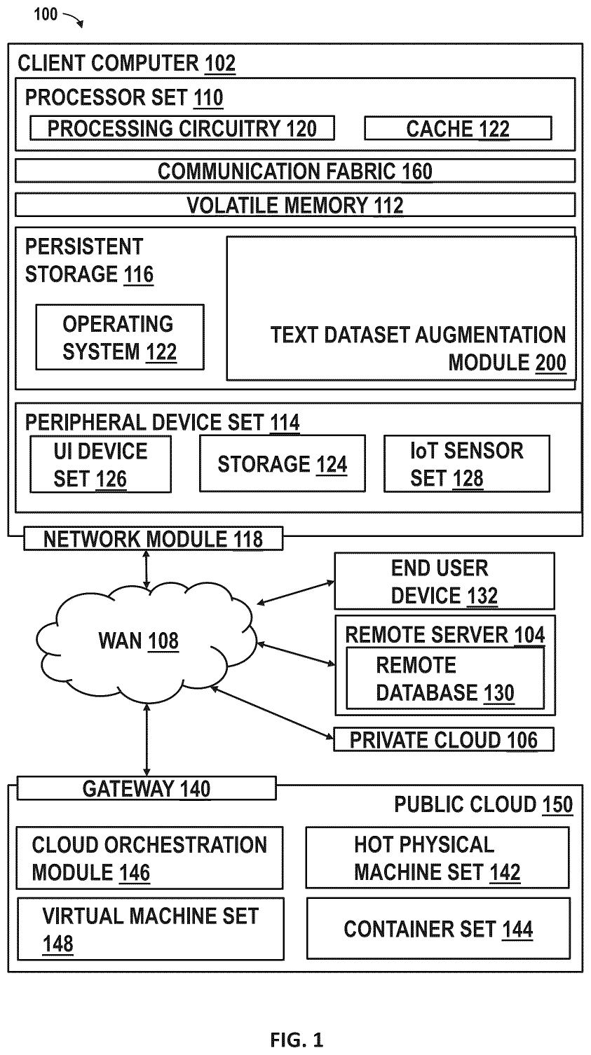

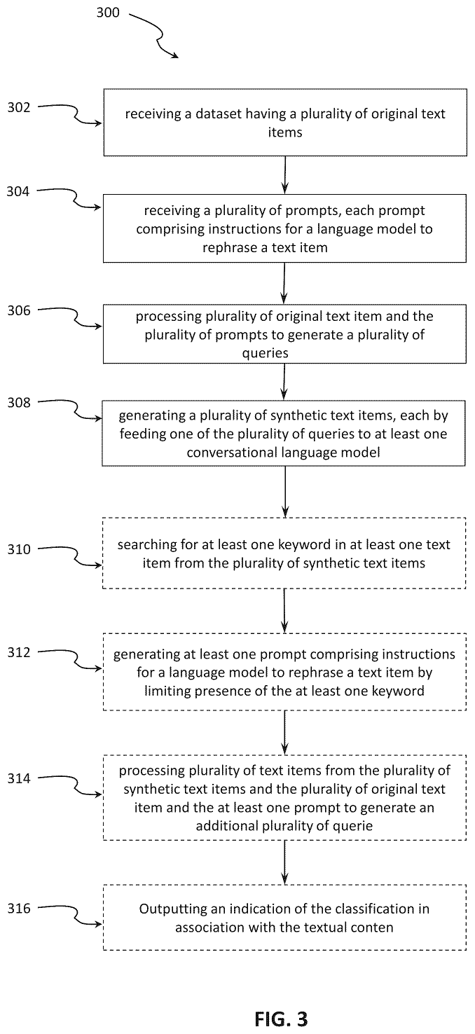

Referring now to the drawings, FIG. 1 is a schematic illustration of an exemplary system for text dataset augmentation, according to some embodiments of the present disclosure. An exemplary client computer system 100 may be used for executing execute processes such as 300 for text classification. Further details about these exemplary processes follow as FIG. 3 are described.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations may be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a text dataset augmentation module 200. In addition to block 200, computing environment 100 includes, for example, computer 102, wide area network (WAN) 108, end user device (EUD) 132, remote server 104, public cloud 150, and private cloud 106. In this embodiment, computer 102 includes processor set 110 (including processing circuitry 120 and cache 134), communication fabric 160, volatile memory 112, persistent storage 116 (including operating system 122 and block 200, as identified above), peripheral device set 114 (including user interface (UI), device set 126, storage 124, and Internet of Things (IoT) sensor set 128), and network module 118. Remote server 104 includes remote database 130. Public cloud 150 includes gateway 140, cloud orchestration module 146, host physical machine set 142, virtual machine set 148, and container set 144.

COMPUTER 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

PROCESSOR SET 110 includes one, or more, computer processors of any type now known or to be developed in the future. For example, a processor set may include one or more of a central processing unit (CPU), a microcontroller, a parallel processor, supporting multiple data such as a digital signal processing (DSP) unit, a graphical processing unit (GPU) module, and the like, as well as optical processors, quantum processors, and processing units based on technologies that may be developed in the future. Processing circuitry 120 may be distributed over multiple packages, for example, multiple, coordinated integrated circuit chips. Processing circuitry 120 may implement multiple processor threads and/or multiple processor cores. Cache 134 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 102 to cause a series of operational steps to be performed by processor set 110 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 134 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 116.

COMMUNICATION FABRIC 160 is the signal conduction paths that allow the various components of computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 102, the volatile memory 112 is located in a single package and is internal to computer 102, but, alternatively or additionally, the volatile memory may be distributed over multiple packages and/or located externally with respect to computer 102.

PERSISTENT STORAGE 116 is any form of non-volatile storage for computers that is now known or to be developed in the future. The non-volatility of this storage means that the stored data is maintained regardless of whether power is being supplied to computer 102 and/or directly to persistent storage 116. Persistent storage 116 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 126 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. IoT sensor set 128 is made up of sensors that can be used in Internet of Things applications. For example, one sensor may be a thermometer and another sensor may be a motion detector.

NETWORK MODULE 118 is the collection of computer software, hardware, and firmware that allows computer 102 to communicate with other computers through WAN 108. Network module 118 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 118 are performed on the same physical hardware device. In other embodiments (for example, embodiments that utilize software-defined networking (SDN)), the control functions and the forwarding functions of network module 118 are performed on physically separate devices, such that the control functions manage several different network hardware devices. Computer readable program instructions for performing the inventive methods can typically be downloaded to computer 102 from an external computer or external storage device through a network adapter card or network interface included in network module 118.

WAN 108 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 132 is any computer system that is used and controlled by an end user (for example, a customer of an enterprise that operates computer 102), and may take any of the forms discussed above in connection with computer 102. EUD 132 typically receives helpful and useful data from the operations of computer 102. For example, in a hypothetical case where computer 102 is designed to provide a recommendation to an end user, this recommendation would typically be communicated from network module 118 of computer 102 through WAN 108 to EUD 132. In this way, EUD 132 can display, or otherwise present, the recommendation to an end user. In some embodiments, EUD 132 may be a client device, such as thin client, heavy client, mainframe computer, desktop computer and so on.

REMOTE SERVER 104 is any computer system that serves at least some data and/or functionality to computer 102. Remote server 104 may be controlled and used by the same entity that operates computer 102. Remote server 104 represents the machine(s) that collect and store helpful and useful data for use by other computers, such as computer 102. For example, in a hypothetical case where computer 102 is designed and programmed to provide a recommendation based on historical data, then this historical data may be provided to computer 102 from remote database 130 of remote server 104.

PUBLIC CLOUD 150 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 150 is performed by the computer hardware and/or software of cloud orchestration module 146. The computing resources provided by public cloud 150 are typically implemented by virtual computing environments that run on various computers making up the computers of host physical machine set 142, which is the universe of physical computers in and/or available to public cloud 150. The virtual computing environments (VCEs) typically take the form of virtual machines from virtual machine set 148 and/or containers from container set 144. It is understood that these VCEs may be stored as images and may be transferred among and between the various physical machine hosts, either as images or after instantiation of the VCE. Cloud orchestration module 146 manages the transfer and storage of images, deploys new instantiations of VCEs and manages active instantiations of VCE deployments. Gateway 140 is the collection of computer software, hardware, and firmware that allows public cloud 150 to communicate through WAN 108.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 150, except that the computing resources are only available for use by a single enterprise. While private cloud 106 is depicted as being in communication with WAN 108, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 150 and private cloud 106 are both part of a larger hybrid cloud.

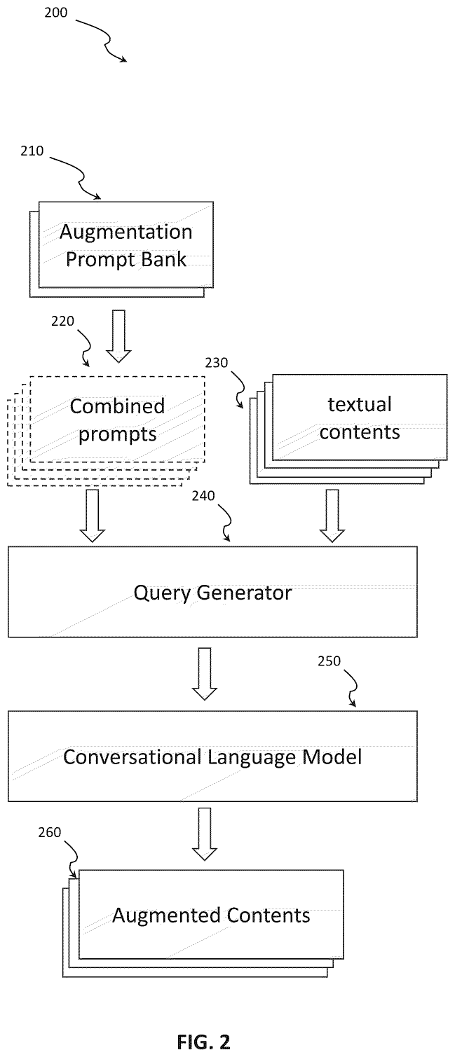

Referring now to FIG. 2, which is a schematic diagram of a simplified exemplary text dataset augmentation module, according to some embodiments of the present disclosure.

The diagram describes the primary essential and an optional architectural component of the text dataset augmentation module 200.

The augmentation prompt bank 210 may comprise configuration switches, directives, instructions, queries, and/or the aimed to cause a conversational or other generative language model to generate different texts based on a textual content which may correspond to a label assigned to the textual content. 210 may be stored in storage such as 124, received from an end user device 132, the public cloud 150, the UI device set 126, and/or the like.

The prompt bank may also be entered or received as text, extracted from a different media, encoded, embedded, and/or the like. The textual content may be in a variety of languages, dialects, jargons, and the likes.

The optional combined prompts 220 may be generated based on two or more aspects of a target prompt. For example, a scheme may comprise a set of moods such as “happy”, “serious”, “sad”, fearful” and “hopeful”, a set of formats such as “Limerick”, “Sonnet”, “Cinquain” and “Haiku”, a set of positions such as “manager”, “Waiter, “medic” and “student”, and a set of origins such as “Greek”, “English”, “Italian” and “Indian”.

Combined prompts generated by this scheme may be “Write a sad Haiku as a Greek medic would write, which teaches the information in the following paragraph” or “Write a serious Sonnet as an English student would write, which teaches the information in the following paragraph”.

In some implementations the prompts may be combined directly, using a set of rules, or using a machine learning model, for example a generative conversational language model.

The textual contents 230 may be extracted from a dataset, and each may comprise a word, a phrase, a sentence, a paragraph, and/or the like. 230 may be received from an end user device 132, the public cloud 150, the UI device set 126, and/or the like, and it may be a text message, an email, a letter, a blog post, a question, and/or the like.

The textual content may also be entered or received as text, or extracted from a voice recording, a video, and/or the like. The textual content may be in a variety of languages, dialects, jargons, and the likes.

Some implementations of the disclosure, for example those used on languages other than English, which have lesser representation in available training data, and thus handled less effectively, may comprise a language adaptation module, for translating the textual content from a first language to a second language.

The language adaptation module may translate the textual content from a first language to a second language. It should also be noted that many natural language processing based translation methods, also referred to as Neural Machine Translation (NMT) such as Bidirectional Encoder Representations from Transformers (BERT) require less training data to achieve adequate reliability such as 90%, 95% or 99% than conversational models require, and are thus accessible for less ubiquitous languages.

The query generator 240 is used for generating a plurality of queries each from a combination of the textual content and one of the plurality of close ended questions.

For example, when the text is “Hi Danielle, what do you want to order for lunch”, some queries to the model may be “Rephrase ‘Hi Danielle, what do you want to order for lunch’ without using terms referring to meals”, “Rephrase ‘Hi Danielle, what do you want to order for lunch’ using Texan dialect”, and/or the like.

Some implementation may also split the text to several, partially overlapping and/or non-overlapping parts, provided these parts contain enough parts to correspond to the label assigned to the textual content in supervised learning content. Other methods of merging text with questions may be used, such as, combining in an embedding space.

The conversational language model 250 may be an artificial intelligence module designed to generate text based on a given prompt or input. The model may be an incorporated in house or third party machine learning model, which was trained on a large corpus of text and may use deterministic or statistical techniques to generate outputs that are coherent, contextually relevant and semantically meaningful. The language model may be designed to analyze a natural language text and generate responses such as those expected in human conversation. The conversational language may be trained specifically for text classification, however models trained for variety of applications, such as chat-bots, virtual assistants, private tutor or psychotherapist emulation and customer service systems may also be used.

Conversational and other generative language models may be powered by advanced machine learning techniques, such as neural networks, and may be fine-tuned to perform specific tasks or to generate outputs in specific domains. Conversational language models may comprise components such as generative transformer network, for example for embedding a word placement in a sentence. Some generative language models comprise one or more autoregressive components, however deterministic methods may also be used.

The models may also be integrated into other systems to provide enhanced capabilities, such as improved natural language processing, text generation, and dialogue management. Followingly, the inferences from the language model may be acquired to form a structure to feed into a decision model to acquire a classification of the textual content.

The augmented contents 260 may include various variations of textual contents, for example the prompt “Rephrase ‘Hi Danielle, what do you want to order for lunch’ using Texan dialect”, may cause a conversational language model may generate “Howdy, Danielle! Whatcha fixin′ to chow down on for lunch?” and/or “Howdy there, Danielle! What's on your mind for grubbin′ on during lunchtime?”.

Referring now to FIG. 3, which is a flowchart of an exemplary process for text dataset augmentation, according to some embodiments of the present disclosure. The processing circuitry 120 may execute the exemplary process 300 for a generating a dataset for variety of purposes such as sentiment analysis, medical screening, text classification, and/or the like. Alternatively, the process 300 or parts thereof may be executing using a remote system, an auxiliary system, and/or the like.

The exemplary process 300 starts, as shown in 302, with receiving a dataset having a plurality of original text items.

The dataset may comprise textual contents, for example 230, and may be received by the system through a user interface of the UI device set 126, network module 118, or other data input mechanism. The received text may be stored in volatile memory 112, cache, 122 peripheral storage 124, or the like, to be processed by the system for various applications, such as natural language processing based text classification. In some implementation non-textual data may also be present in the dataset, either as additional modalities, or as content convertible to text.

The exemplary process 300 continues, as shown in 304, with receiving a plurality of prompts, each prompt comprising instructions for a language model to rephrase a text item

The prompts may be designed in order to instruct one or more generative AI models, also known as large language models, or conversational language models, to rephrase one or more textual contents, optionally with adjustment of model parameters.

Modifying parameters pertaining to conversational language model, such as context window length or temperature may further increase variety of variants generated thereby.

These parameters can be used to augment the text phrases, and can also be used in feedback loop from the trained ML model. For example a first iteration may augmentations with very low temperature or randomness. Provided the items are matching and coherent examples, increasing the temperature and applying and additional iteration of the generative language model used for augmentation, may contribute to the robustness and performance, of the model to be trained using the augmented data, due to wider variation in training text items. Lower accuracy of the synthetic items may indicate the temperature should be lowered.

The prompts may instruct the conversational language model to change the length, language style change emotional tone, use slang, write similarly to some famous writer's style and/or the like.

Some implementations may comprise one or more instructions from the instructions for a language model to rephrase a text item refers to detail level of the text item, for example to terse, or to elaborate further. Exemplary prompts may be “Rephrase the following text in a somewhat more concise manner”.

Some implementations may also comprise one or more instructions from the instructions for a language model to rephrase a text item by emotional tone of the text item, such as raising or lowering excitement level, sadness, happiness, and/or the like. Exemplary prompts may be “Rephrase the following text in a somewhat more positive attitude”.

Some implementations may also comprise one or more instructions from the instructions for a language model to rephrase a text item by dialect of the text item. The dialect may relate to a profession, language knowledge level, a region, a country of origin, and/or the like. Exemplary prompts may be “Rephrase the following text as a new Yorker employed as an interior designer is likely to”, or rephrase the following text in basic, beginner level English”

Some implementations may also comprise one or more instructions from the instructions for a language model to rephrase a text item by personal writer style of the text item. The augmentation of this type may work best when there are plenty of associated examples accessible, therefore a famous writer, journalist, author, and/like may be preferred, however less known writers may also be used a style basis. Exemplary prompts may be “Rephrase the following text in a Shakespeare's style”.

One or more instruction from the instructions for a language model to rephrase a text item may refer to presence of one or more words, phrases and/or the like in the text item, such as avoiding the use of specific terms or phrases, for example when a word is associated with a label assigned to the text item, such as a “plant” when the label is “botany”

Some implementations may apply pre-made set of instruction templates is used to take an initial set of training texts and enhance it to create a much larger, richer set of training texts, so as to better train ML models on them for classification, fact inference and/or the like. Other aspects of the text such as language,

The exemplary process 300 continues, as shown in 306, with processing plurality of original text item and the plurality of prompts to generate a plurality of queries. The plurality of original text item may be extracted, as shown in 302, from the to the textual contents 230, and combined with a plurality of prompts, for example from the augmentation prompt bank 210 and/or the optional combined prompts 220 which may be obtained from on volatile memory 112, peripheral storage 124, remotely on a private cloud 106, on non-volatile memory and/or the like. A combined query from the plurality of queries may be, for example “Rephrase the text ‘all the customers were satisfied’ in a more elaborate, and funny manner”. Or “Rewrite the following text as a Haiku “The vegetation in arid area, with less than 20 cm of yearly rainfall is usually sparse”. Some alternative implementation may combine the prompts and the text items using embedding or other encoding.

The exemplary process 300 continues, as shown in 308, with generating a plurality of synthetic text items, each by feeding one of the plurality of queries to at least one conversational language model.

The conversational language model may be executed by the processor set 110, or remotely on the private cloud 106, or the public cloud 150, and/or the like.

The conversational language model such as 250 may be models such as or based on Generative Pretrained Transformer (GPT), Conditional Transformer Language Model (CTRL), Text-to-Text Transfer Transformer (T5), Recurrent neural networks (RNN), Generative Adversarial Networks (GANs), variational autoencoders, and/or the like, as well as models that are expected to be developed. Some implementations may also comprise a knowledge representation based module, which may be deterministic or stochastic. The conversational language model may generate answers which comprise one of a plurality of answers such as “Yes” and “No”, a number in a range, and/or the like, and these inferences may be fed directly or filtered to a decision model.

The synthetic text items may be a multiplication of prompts and original text items, however some prompts may be suited for part of the text items, and different items may be generated using the same prompt with a different conversational language model, different configurations of the conversational language model, and in some cases by the same generative model due to inherent randomness.

The exemplary process 300 may continue, as shown in 310, with searching for at least one keyword in at least one text item from the plurality of synthetic text items.

An iterative approach can be implemented where the machine learning model is used to identify key words or phrases, and then generate further instructions for a language model to generate new text, similar to the prior one but without these key words/phrases. This may help increase flexibility and robustness and reduce reliance on specific words. Rephrase a text item in relation to presence of one or more words in the text item, for examples words associated with a label assigned to the text item, is an example where the iterative approach may contribute to a dataset variety.

As an example, if the word ‘money’ appears as a most used indicator for the ML model to classify the text as ‘financial’, the instruction “rephrase this text without using the word ‘Money’” may create new samples of financial text samples, that will train a more broad ML model

For another example, a list of a number of most common words appearing in text items, original, synthetic or both, for example top 3, 5 or 10 most common words phrases and/or the like.

For example, when the label is “vacation”, the top 4 most popular words may be “relaxation”, “beach”, “travel” and “adventure”. The process may be iterative, and a following iteration may remove a new top 4 such as “leisure”, “escape”, “exploration” and “rest”.

The exemplary process 300 may continue, as shown in 312, with generating at least one prompt comprising instructions for a language model to rephrase a text item by limiting presence of the at least one keyword.

For example a prompt may be “rephrase the following sentence, without using the words relaxation, beach, travel and adventure”. Some implementations may choose some of this words or limit the numbers, for example “rewrite the following paragraph, without using the words relaxation, travel and adventure more than once”. Some implementations may generate the instruction in different formats, such as computer programming language or embedded manner.

The exemplary process 300 may continue, as shown in 314, with processing plurality of text items from the plurality of synthetic text items and the plurality of original text item and the at least one prompt to generate an additional plurality of queries.

Similarly to 306, the at least one prompt generated in 312 may be combined with the original text items, and/or optionally synthetic text items, to generate an additional plurality of queries, such as “rewrite the sentence without using any of the words relaxation, travel, leisure, rest, resort and adventure”

And subsequently, as shown in 316, the process 300 may continue by generating at least one additional synthetic text item, by feeding at least one of the additional plurality of queries to at least one conversational language model.

Similarly to 308, at least one additional synthetic text item may be generated using prompts that were not originally available in an iterative manner, increasing the variety of texts.

Some implementation may apply additional iteration based on the second iteration and so forth.

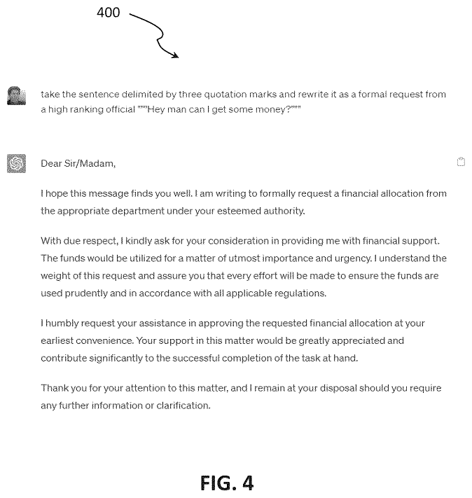

Referring now to FIG. 4, which is an exemplary usage of a prompt on a conversational language module for text dataset item augmentation, according to some embodiments of the present disclosure.

The example shows a request to GPT 3 to generate a formal request to finance. An exemplary letter is generated. Note that the same prompt may be used to cause the model to generate additional letters with different phrases as the model has inherent randomness under many configurations of parameters.

It is expected that during the life of a patent maturing from this application many relevant conversational language models, text media, and representation methods will be developed and the scope of the terms conversational language models machine learning model, text, and embedding are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for augmenting a dataset comprising textual content, comprising:
receiving a dataset having a plurality of original text items;
receiving a plurality of prompts, each prompt comprising instructions for a language model to rephrase a text item;
processing plurality of original text item and the plurality of prompts to generate a plurality of queries; and
generating a plurality of synthetic text items, each by feeding one of the plurality of queries to at least one conversational language model.

2. The method of claim 1, further comprising modifying at least one parameter pertaining to the at least one conversational language model.

3. The method of claim 1, wherein at least one instruction from the instructions for a language model to rephrase a text item refers to detail level of the text item.

4. The method of claim 1, wherein at least one instruction from the instructions for a language model to rephrase a text item refers to emotional tone of the text item.

5. The method of claim 1, wherein at least one instruction from the instructions for a language model to rephrase a text item refers to dialect of the text item.

6. The method of claim 1, wherein at least one instruction from the instructions for a language model to rephrase a text item refers to personal writer style of the text item.

7. The method of claim 1, wherein at least one instruction from the instructions for a language model to rephrase a text item refers to presence of at least one word in the text item.

8. The method of claim 7, wherein the at least one word is a word associated with a label assigned to the text item.

9. The method of claim 7, further comprising at least one iteration comprising:
searching for at least one keyword in at least one text item from the plurality of synthetic text items;
generating at least one prompt comprising instructions for a language model to rephrase a text item by limiting presence of the at least one keyword;
processing plurality of text items from the plurality of synthetic text items and the plurality of original text item and the at least one prompt to generate an additional plurality of queries; and
generating at least one additional synthetic text item, by feeding at least one of the additional plurality of queries to at least one conversational language model.

10. A system comprising a storage and at least one processing circuitry configured to:
receive a dataset having a plurality of original text items;
receive a plurality of prompts, each prompt comprising instructions for a language model to rephrase a text item;
process plurality of original text item and the plurality of prompts to generate a plurality of queries; and
generate a plurality of synthetic text items, each by feeding one of the plurality of queries to at least one conversational language model.

11. The system of claim 10, further comprising modifying at least one parameter pertaining to the at least one conversational language model.

12. The system of claim 10, wherein at least one instruction from the instructions for a language model to rephrase a text item refers to detail level of the text item.

13. The system of claim 10, wherein at least one instruction from the instructions for a language model to rephrase a text item refers to emotional tone of the text item.

14. The system of claim 10, wherein at least one instruction from the instructions for a language model to rephrase a text item refers to dialect of the text item.

15. The system of claim 10, wherein at least one instruction from the instructions for a language model to rephrase a text item refers to personal writer style of the text item.

16. The system of claim 10, wherein at least one instruction from the instructions for a language model to rephrase a text item refers to presence of at least one word in the text item.

17. The system of claim 16, wherein the at least one word is a word associated with a label assigned to the text item.

18. The system of claim 16, further comprising at least one iteration comprising:
searching for at least one keyword in at least one text item from the plurality of synthetic text items;
generating at least one prompt comprising instructions for a language model to rephrase a text item by limiting presence of the at least one keyword;
processing plurality of text items from the plurality of synthetic text items and the plurality of original text item and the at least one prompt to generate an additional plurality of queries; and
generating at least one additional synthetic text item, by feeding at least one of the additional plurality of queries to at least one conversational language model.

19. One or more computer program products comprising instructions for augmenting a dataset comprising a textual content, wherein execution of the instructions by one or more processors of a computing system is to cause a computing system to:
receive a dataset having a plurality of original text items;
receive a plurality of prompts, each prompt comprising instructions for a language model to rephrase a text item;
process plurality of original text item and the plurality of prompts to generate a plurality of queries; and
generate a plurality of synthetic text items, each by feeding one of the plurality of queries to at least one conversational language model.
